(19) United States
(12) Patent Application Publication
(10) Pub. No.: US 2024/0300022 A1
(43) Pub. Date: Sep. 12, 2024

(54) PREDICTING A MATERIAL PROPERTY, GENERATING A COMPONENT, COMPONENT, SYSTEM

(71) Applicant: Siemens Industry Software NV, Leuven (BE)

(72) Inventor: Nicolas Lammens, Herent (BE)

(21) Appl. No.: 18/589,731

(22) Filed: Feb. 28, 2024

(30) Foreign Application Priority Data
Mar. 8, 2023 (EP) 23160753.2

(51) Int. Cl. B22F 10/80; B33Y 50/00; G06F 30/20

(52) U.S. Cl. CPC B22F 10/80; B33Y 50/00; G06F 30/20

(57) ABSTRACT

A method for predicting a material property of a component made by additive manufacturing includes: defining an area of interest and generating a mesh in the area of interest; providing a temperature model during the additive manufacturing process; providing a process parameter set; calculating a thermal history in the area of interest based on the process parameter set using the temperature model; and determining a solidification gradient and a solidification front velocity in the area of interest from the thermal history. To obtain reasonable material predictions, the method may further include: reducing the data set of solidification gradients (SGR) and solidification front velocities; determining microstructure characteristics for the reduced data set by microstructural modelling; determining the material property for the reduced data set using a material property model; and interpolating of material property from the solidification gradient and solidification front velocity for the nodes within the area of interest.

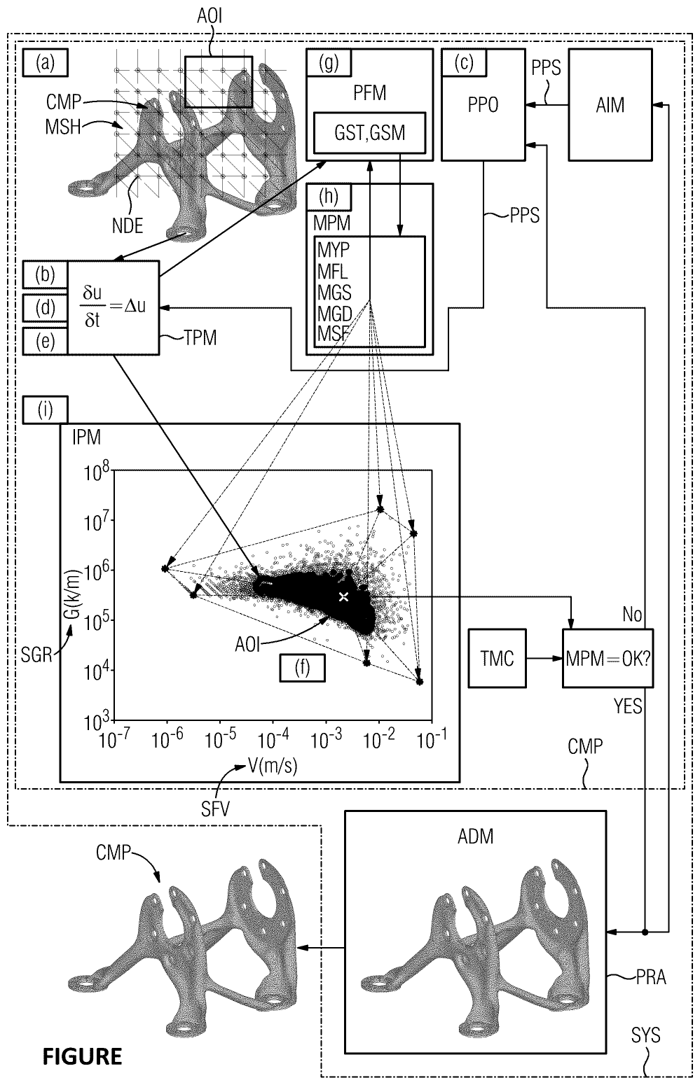

The present patent document claims the benefit of European Patent Application No. 23160753.2, filed Mar. 8, 2023, which is hereby incorporated by reference in its entirety.

### TECHNICAL FIELD

The disclosure relates to a method for predicting a material property of a component made by additive manufacturing. Further, the disclosure deals with generating a component by additive manufacturing. The disclosure also relates to a system for carrying out such method, a system for additively manufacturing such component, and the manufactured component itself. The disclosure also deals with predicting microstructure driven material properties.

### BACKGROUND

The challenge in predicting material performance in additive manufacturing, e.g., in laser powder-bed fusion additive manufacturing (LPBF-AM) arises from the specific process wherein powder metal is molten and solidified using a laser beam. The consequence is that heating/cooldown happens at a very local scale (e.g., on the order of microns) and short timespans (e.g., on the order of 10⁶ K/s cooldown), while an entire component has dimensions on the order of centimeters with a print process taking multiple hours.

This large difference in scales (microns vs centimeters, microseconds vs hours) complicates part-scale material prediction in additive manufacturing.

Furthermore, geometrical effects, (e.g., thin walls or overhangs and the multitude of process parameters like laser power, laser scan speed, laser scan pattern/path), result in local variations of the thermal history throughout a component during the generation. The thermal history results in variable microstructural features throughout an additive manufactured component, requiring a part-scale analysis to properly predict final performance. The microstructural features are mainly solidification artefacts such as grain size, grain orientation, or grain shape. These features strongly impact the mechanical performance of the material and may be anisotropic.

To fully account for the local variations in microstructure (and the resulting material properties), state-of-the-art methods require a chain of time-consuming simulations at the scale of the individual grains in the microstructure, and time-steps on the order of microseconds (or smaller). When executed on even the smallest of models, this chain of simulations requires high-performance computing infrastructure and weeks or even months of computation time to obtain results, making their application to a full industrially relevant part unfeasible for the foreseeable future.

An example of dimensions in such calculation may be given as an example indication of what may be expected:

A component may be 6 cm in height. The laser has a spot-size of just 100 μm, a single layer of powder material is 60 μm thick. A total of 2 million scan vectors is needed to print this part. The full thermal history of each of these scan vectors needs to be considered. The total print time for a single print of this part is about 10 hours. Average cooldown speeds in the part are about 10⁴-10⁵K/s. To be accurate within 100K (which is still insufficient for this type of analysis) would require 4-40 million timesteps in the thermal analysis.

These numbers only refer to the challenge of predicting the thermal field. The complexities of computing microstructure and material properties may be considered as even more complex and demanding.

One known approach to capture the microstructure resulting from the additive manufacturing process is the ExaAM project at Oak Ridge (https://www.ornl.gov/project/exaam-transforming-additive-manufacturing-through-exascale-simulation). This approach uses state-of-the-art coding practice (e.g., multi-threading, parallelization, GPU acceleration) to accelerate the large-scale computations and then use exascale computing infrastructure (exascale computing refers to supercomputing systems that may calculate at least 1018 (one quintillion) operations per second). Such an approach may be understood as “brute force” to perform the required simulations on the part level.

Known methods of determination of material performance include:
(1) Karayagiz Kubra ET AL: “Finite interface dissipation phase field modeling of Ni—Nb under additive manufacturing conditions”, ACTA MATERIALIA, vol. 185, 20 Feb. 2020 (2020 Feb. 20), pages 320-339, XP93068946, GB, ISSN: 1359-6454, DOI: 10.1016/j.actamat. 2019.11.057; URL:https://arxiv.org/pdf/1906.10200.pdf;
(2) SUPRIYO GHOSH ET AL: “Simulation and analysis of gamma-Ni cellular growth during laser powder deposition of Ni-based superalloys”, ARXIV.org, CORNELL UNIVERSITY LIBRARY, 201 OLIN LIBRARY CORNELL UNIVERSITY ITHACA, NY 14853, 18 Jul. 2017 (2017 Jul. 18), XP080777716, URL:https://www.sciencedirect.com/science/article/pii/S0927025617307279; (3) David S. A. ET AL: “Correlation between solidification parameters and weid microstructures”, INTERNATIONAL MATERIALS REVIEWS, vol. 34, no. 1, 1 Jan. 1989 (1989 Jan. 1), pages 213-245, XP93068950, US, ISSN: 0950-6608, DOI: 10.1179/imr.1989.34.1.213 URL:https://www.tandfonline.com/doi/abs/10.1179/imr.1989.34.1.213; (4) SUPRIYO GHOSH ET AL: “Uncertainty analysis of microsegregation during laser powder bed fusion”, MODELLING AND SIMULATION IN MATERIALS SCIENCE AND ENGINEERING, IOP PUBLISHING, BRISTOL, GB, vol. 27, no. 3, 25 Feb. 2019 (2019 Feb. 25), page 34002, XP020339655, ISSN: 0965-0393, DOI: 10.1088/1361-651 X/AB01 BF.

### SUMMARY AND DESCRIPTION

Based on the art described above and the problems associated, the disclosure is based on the task of improving the process to improve the design and prediction of component performance, in particular regarding the material performance of a component in the field of additive manufacturing.

It is another objective to reduce the computational effort of determining and predicting the material and component performance of an additive manufactured part.

Metal component performance is driven by a combination of the geometry, loading conditions, and the material performance. A focus of this disclosure is on the material performance influenced by the material microstructure.

The scope of the present disclosure is defined solely by the appended claims and is not affected to any degree by the statements within this summary. The present embodiments may obviate one or more of the drawbacks or limitations in the related art.

In accordance with the disclosure, a solution is provided for the above-described problems by the incipiently defined method that includes: (f) reducing the data set of solidification gradients and solidification front velocities such that every data point of the data set may be approximated by interpolation; (g) determining microstructure characteristics for the reduced data set based on the thermal history of the respective node by microstructural modelling, interpolating a solidification gradient and solidification front velocity for the nodes within the area of interest; and (h) determining the material property for the nodes within the reduced dataset from the microstructure characteristics using a material property model, and (i) interpolating of material property from the solidification gradient and solidification front velocity for the nodes within the area of interest.

In certain examples, the disclosure proposes to obtain reasonable material predictions by a simplified method for fast prediction of microstructurally driven material performance at the part scale for AM components.

The material properties determined from the interpolation act (i) may be output via a human machine interface. This may be done using a display. The material properties determined from the interpolation act (i) may be stored in a storage device to be used for further design improvement or for generation of the component. The material properties determined from the interpolation act (i) may be postprocessed such that the data may be output graphically via a display illustrating the parameters to a user as one or several images.

Improving material properties may be termed as improving the material or component performance, in particular metal component performance. Examples of material performance include: strength, hardness, flexibility, durability, thermal conductivity, electrical conductivity, corrosion resistance, friction coefficient, impact resistance, or optical properties.

In one example, the field of application may be laser powder-bed fusion additive manufacturing.

Defining an area of interest of the component may extend to the entire component. Generating a mesh will then (as well as the following acts referring to the area of interest) be performed for the entire component, too.

The term “material performance” herein may refer to the performance regarding at least one of the properties stiffness, strength, durability, fatigue, or yield.

Influences of component geometry and loading conditions may be obtained using the conventional Computer Aided Design (CAD) and Finite Element (FE) approaches also used for other manufacturing methods. The disclosure instead focusses on material performance.

Neglecting the immense time required when combining a microstructural simulation and a material property model with a thermal simulation for the full component enables to obtain similar results because such process uses some of the same technical building blocks such as microstructural modelling or phase field modelling and thermal modelling. But such simulation would require, even when applying the most powerful computer systems available, at least several months of calculation for one single component. The disclosure proposes a method to reduce the number of computations needed, that is, a specific manner of calculating only a limited subset within the component and interpolating those results to the full component. This is done by using the solidification gradient and solidification front velocity as a working coordinate. The immediate benefits are a time and cost-wise reduction of resources. Further, micro-level simulations for a full part quickly adds up to gigabytes or even terabytes of storage requirements for simple parts. The disclosure therefore enables significantly saving storage space, too.

The disclosure target-oriented applies computational resources to a physical problem underlying the technical task of effectively additively manufacture with the desired mechanical performance. Conventional methods do not realistically enable a sufficiently accurate prediction of mechanical strength parameters of a component resulting in an enormous amount of generated waste parts when it comes to components that have certain mechanical properties, like a certain deformation under specific load or must be able to withstand a certain mechanical load. Conventionally there may be a mismatch in simulation and reality, e.g., the component deforms more than expected, starts to crack early, fails prematurely. The disclosure avoids such mismatches more efficiently.

In certain examples, material performance prediction has not been attempted at the part level and may be restricted to (very) small sub-models of the complete component. In these methods, selecting the location for a sub-model is left as a user decision (potentially missing critical sections) and no solution is provided to merge the sub-model scaled results into a part-level analysis. The disclosure uses an automatic identification of which locations to analyze and how to interpolate those results to the full component by the act of reducing the data set of solidification gradients and solidification front velocities such that every data point of the data set may be approximated by interpolation.

The process may include the following acts: (1) fast prediction of part-scale thermal history; (2) extraction of solidification gradient and solidification front velocity in each point of the model; (3) data reduction to minimal set of solidification gradient and solidification front velocity encompassing the entire part; (4) microstructural prediction and material property prediction on reduced solidification gradient and solidification front velocity field; and (5) interpolation of material property to all points within the model using the solidification gradient and solidification front velocity field as a working coordinate.

Herein, acts 3, 4, and 5 are important for significantly saving computational power.

Act 5 corresponding to step (h) referring to interpolating of material property for the nodes within the area of interest may be understood as applying the rule of three to known triples of solidification gradient and solidification front velocity and material property using the space of solidification gradient and solidification front velocity as a working coordinate for determining the material property. The space of solidification gradient and solidification front velocity may be a 2-dimensional field.

Furthermore, generating a component, a component, and a system are provided herein.

One embodiment applies act (f) such that when selecting the reduced the data set of solidification gradients and solidification front velocities from the data set such that the reduced data set encompasses the data set of the entire area of interest in a 2-dimensional field space of solidification gradients and solidification front velocities such that the data set may be approximated by interpolation from the reduced data set. This embodiment guarantees that every single set of solidification gradient and solidification front velocity for the entire area of interest of the component may be addressed by interpolation of the reduced data set.

Another embodiment provides the reduced data set encompassing the data set of the entire area of interest in a 2-dimensional field of solidification gradients and solidification front velocities such that when connecting each point of the reduced data set to its two neighbors of the reduced data set the data set is encircled by the resulting connection line track. In a more than 2-dimensional space for the working coordinate of the interpolation, the data set is to be enveloped by the reduced data set. This process or test enables to efficiently guarantee that the entire field of solidification gradients and solidification front velocities is encompassed by the reduced data set. This kind of line-connection test shows how many points the reduced data set needs to enable interpolation throughout the complete area of interest.

Another embodiment provides using microstructural modelling in act (g) is done using thermal-history-microstructure-modelling. Thermal-history-microstructure-modelling refers to any kind of modelling for determining the microstructure from the thermal history of the solidifying material. This may be done by one of several known tools. Known examples are the commercially available tools “cellular automata” or “phase field modelling” for the microstructural modelling in act (g). Cellular automata modelling leads to good results for this physical technical application of determining the microstructure characteristics.

Another embodiment provides using microstructure-material-property-modelling for the material modelling in act (h). Microstructure-material-property-modelling refers to any kind of modelling for determining material properties from the microstructure of the solidified material. Currently the prevailing technology here is crystal plasticity. These material property prognoses are sufficiently accurate. Further, empirical rules may be applied for material modelling but those are not very general in applicability.

Still another embodiment provides defining a target material property criterium and repeating acts (c)-(i) with a respectively changed additive manufacturing process parameter set until the target material property is fulfilled by the determined material property of act (i).

The first additive manufacturing process parameter set provided in act (c) may be—in a simplest embodiment—a standard set without any variation of the process parameters between the process acts regardless of the component geometry. This parameter set will most likely not lead to optimal results. Alternatively, a set may be applied which is known from processing a similar part.

Alternatively, an artificial intelligence (AI) module may be used to provide the first set. The AI-module may be trained by known successful component generations. Such an AI-module may receive the component geometry as an input and outputs the additive manufacturing process parameter set.

The optimization or improvement of the additive manufacturing process parameter set may be done by iteration. A process parameter optimizer may be used applying a standard optimization strategy like: stepwise variation of single parameters when processing these variations by applying the prediction method; evaluation of the variation effect and selecting a few variations with the most beneficial effects; following the most promising variations during variation of other parameters of the additive manufacturing process parameter set; and follow this process until all parameters have been varied and finally choose the best additive manufacturing process parameter set.

Other improvement strategies may be used leading to better improvements or a different local or global optimum.

The method for predicting a material property as defined herein may be an integral process of a method for generating a component. This method may combine the method for predicting or improving a component's material property and further additively manufacturing the component applying the process parameter set obtained from the prediction/improvement process resulting in the desired material properties, e.g., as determined by the iteration.

Further, a system including at least one computer is disclosed for carrying out a method for predicting or improving a component's material property or for generating a component. Computer-implemented acts herein may include at least one act or all of the following acts: (d) calculation of a thermal history of nodes of the mesh in the area of interest based on the process parameter set using the temperature model; (e) determination of a solidification gradient and a solidification front velocity for the nodes of the area of interest from the thermal history; (f) reducing the data set of solidification gradients and solidification front velocities such that every data point of the data set may be approximated by interpolation; (g) determination of microstructure characteristics for the reduced data set based on the thermal history of the respective node by microstructural modelling; and/or (h) determining the material property for the nodes within the reduced dataset from the microstructure characteristics using a material property model, interpolating of material property from the solidification gradient and solidification front velocity for the nodes within the area of interest.

The other act disclosed herein may be at least partly or completely computer implemented. For example, the person with ordinary skill in the art knows that the mesh generation in act (a) is done as a computer implemented process. The selection of an area of interest may be done automatically or manually.

The area of interest may be automatically determined on the basis of a known (determined before) mechanical analysis under operational load of the component. This automatism may select or at least recommend to a user an area of relatively high or highest mechanical load (mechanical stress) as an area of interest.

A system including at least one computer for generating a component may include a 3D-printing apparatus.

The disclosure further relates to a material property improved or optimized component obtainable by a method for improving material properties of an additively manufactured component as explained herein.

Further possible implementations or alternative solutions also encompass combinations that are not explicitly mentioned herein of features described above or below with regard to the embodiments. The person skilled in the art may also add individual or isolated aspects and features to the most basic form of the disclosure.

In certain examples, not all acts of the method do not necessarily have to be performed on the same component or computer instance, but may be performed on different computer instances.

In addition, it is possible that individual acts of the method described above may be carried out in one unit and the remaining components in another unit, as a distributed system.

The properties, features, and advantages described above, as well as the manner they are achieved, become clearer and more understandable in the light of the following description and embodiments, which is described in more detail in the context of the drawing. This following description does not limit the disclosure on the contained embodiments. The FIGURE may not be to scale. Further, an embodiment may also be any combination of the dependent claims or above embodiments with the respective independent claim.

### BRIEF DESCRIPTION OF THE DRAWING

Embodiments of the disclosure are now described, by way of example only, with reference to the accompanying drawing, of which:

The FIGURE depicts a flow diagram of an example of a method.

### DESCRIPTION OF THE DRAWING

The FIGURE shows a simplified flow diagram illustrating an example of a method for predicting a material property ADM of a component CMP made by additive manufacturing ADM.

In act (a), an area of interest AOI of the component CMP is defined and a mesh MSH with several nodes NDE at least in that area of interest AOI is generated. This selecting act may be optional. The analysis may be done on the full component. The selecting act would then result in the entire component being selected as area of interest AOI. The mesh MSH generation is done as a computer implemented process.

In act (b), a temperature model TPM for modelling temperature in the area of interest AOI during the additive manufacturing ADM process is provided. This thermal modeling is intentionally kept simple. While the FIGURE illustrates the thermal model TPM as the general equation of heat conduction, the thermal modeling may supply several simplifying assumptions. All material properties are assumed to be constant for the purpose of thermal modeling. The thermal conductivity is assumed to be constant, and no thermal expansion procures. The phase shift is neglected and does not happen in the thermal model. This enables the thermal model TPM to result in a fully analytical solution without the necessity of iterations. For, the more accurate and more complex thermal modeling is possible within the scope of this disclosure. It was found that the degree of simplification as explained herein leads to sufficient accuracy and enables fast results with moderate computing power. Next to the component geometry the thermal modeling receives as an input additive manufacturing process parameters PPS. This may include the laser power, the laser velocity, the laser pass, parameters of the powder used for the additive manufacturing, the powder material layer thickness of each act when building up the component in the enclosure of the additive manufacturing machine, and possibly further details of the additive manufacturing process.

In act (c), these details are generated and provided when providing an additive manufacturing ADM process parameter set PPS. A process parameter optimizer PPO generates and provides these process parameter sets PPS. This process parameter sets PPS may be predefined standard sets which are known to generate good results or may be only a first guess for the first act of iteration. The process parameter optimizer PPO includes the standard optimization technique for automatically providing one or several process parameter sets PPS. When providing these process parameter sets PPS the process parameter optimizer PPO may be supported by an artificial intelligence module AIM.

In act (d), the temperature model TPM calculates a thermal history THT of nodes of the mesh MSH in the area of interest AOI based on the process parameter set PPS using the temperature model TPM. This calculation is done for every node of the mesh MSH.

In act (e), from the thermal history, a solidification gradient SGR and a solidification front velocity SFV for the nodes NDE of the area of interest AOI is determined.

In act (f), as illustrated in the FIGURE, the data set of solidification gradients SGR and solidification front velocities SFV is reduced by selecting a reduced data set RDS from the full data set such that every data point of the data set may be approximated by interpolation. The interpolation is done by an interpolation module IPM. The chart depicted in the interpolation module IPM of the FIGURE shows a <SGR, SFV> map for the component CMP. Each dot in the map represents a node NDE in the model and its corresponding <SGR, SFV> value as calculated in acts (d) and (e). The coordinates of the node are retrievably stored together with the point of solidification gradients SGR and solidification front velocities SFV.

The dashed line illustrates the concept of act (f): a minimum set of <SGR, SFV> combinations is selected that fully encompass the <SGR, SFV> map of the entire component CMP. This effectively reduces the map from 1000's of points and conditions to just a few 10's (here 6) of conditions. Because these few points encompass the entire map of <SGR, SFV> combinations, each point may be reached by interpolation. This may be done or tested by connecting each point of the reduced data set RDS to its two neighbors of the reduced data set RDS. The resulting connection line track encircles the entire data set.

In act (g), once the boundary of the field of solidification gradients SGR and solidification front velocities SFV has been identified from act (f), namely the reduced data set RDS, microstructure characteristics for this reduced data set RDS based on the thermal history THT of the respective node NDE by microstructural modelling PFM, are determined. On the basis of the microstructure characteristics, at least one material property MPP for the nodes NDE within the reduced data set RDS is determined using a material property model MPM.

The predictions themselves may be made using a thermal-history-microstructure-modelling-tool and a microstructure-material-property-modelling-tool. The microstructure may be modelled via a cellular automata or cellular automaton (see: e.g., https://en.wikipedia.org/wiki/Cellular_automaton). The material-property may be determined via crystal plasticity (see e.g.: https://en.wikipedia.org/wiki/Crystal_plasticity). Such tools are commercially available.

During act (g), microstructure characteristics e.g., grain structure GST and grain structure matrix GSM, from the solidification gradient SGR and solidification front velocity SFV for the nodes NDE within the area of interest AOI are determined.

In act (h), these microstructure characteristics are used for determining material properties MPP for the nodes NDE within the area of interest AOI using a material property model MPM.

In act (i), at least one material property MPP is interpolated from the solidification gradient SGR and solidification front velocity SFV for the nodes NDE within the area of interest AOI.

This prediction process of the material property MPP is part of an improvement and/or optimization process for the mechanical features of the component CMP. The interpolation module IPM enables to determine the material properties MPM in the area of interest AOI.

Melted metal powder for a metal component CMP forms grains of specific size, shape, and orientation during the solidification in the additive manufacturing process. These are the microstructure characteristics for a metal component CMP. From these characteristics, material properties are directly determined using the material property model MPM.

These material properties MPP include material yield point MYP, material fatigue life MFL, material grain size MGS, material grain orientation MGD, and/or material stiffness MSF.

A method for improving and optimizing the material properties MPP of the component CMP includes: defining a target material property criterium TMC; and repeating acts (c)-(i) with a respectively changed additive manufacturing ADM process parameter set PPS until the target material property TMP is fulfilled by the determined material property MPP of act (i).

The AI-module AIM may be trained by a feedback of the successful process parameter set PPS leading to acceptable material properties MPP. The AI-module receives the component geometry as an input and outputs the additive manufacturing process parameter set PPS.

The FIGURE also shows a system SYS including a computer CMP or a computer network for carrying the described method. The respective method acts are computer-implemented method acts or partly computer-implemented method acts. This system SYS includes further a 3D-printing apparatus PRA for generating the material property optimized component CMP.

The use of “a” or “an” throughout this application does not exclude a plurality, and “comprising” does not exclude other acts or elements. Also, elements described in association with different embodiments may be combined.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method for predicting a material property of a component made by additive manufacturing, the method comprising:
(a) defining an area of interest of the component and generating a mesh at least in the area of interest;
(b) providing a temperature model for modelling temperature of the area of interest during the additive manufacturing process;
(c) providing an additive manufacturing process parameter set;
(d) calculating a thermal history of nodes of the mesh in the area of interest based on the process parameter set using the temperature model;
(e) determining a solidification gradient and a solidification front velocity for the nodes of the area of interest from the thermal history;
(f) selecting a reduced data set from the data set of solidification gradients and solidification front velocities such that every data point of the data set may be approximated by interpolation from the reduced data set;
(g) determining microstructure characteristics for the reduced data set based on the thermal history of the respective node by microstructural modelling;
(h) determining the material property for the nodes within the reduced data set from the microstructure characteristics using a material property model; and
(i) interpolating the material property from the solidification gradient and solidification front velocity for the nodes within the area of interest.

2. The method of claim 1, wherein the reduced data set encompasses the data set of an entire area of interest in a space of solidification gradients and solidification front velocities such that the data set may be approximated by interpolation from the reduced data set.

3. The method of claim 2, wherein the reduced data set encompasses the data set of the entire area of interest in a 2-dimensional field of solidification gradients and solidification front velocities such that, when connecting each point of the reduced data set to two neighbors of the reduced data set, the data set is encircled by a resulting connection line track.

4. The method of claim 3, wherein the microstructural modelling is performed using thermal-history-microstructure-modelling.

5. The method of claim 4, wherein the material modelling is performed using microstructure-material-property-modelling.

6. The method of claim 5, further comprising:
defining a target material property criterium; and
repeating acts (c) through (i) with a changed additive manufacturing process parameter set for each iteration until the target material property criterium is fulfilled by the determined material property of act (i).

7. The method of claim 6, further comprising:
additively manufacturing the component applying the process parameter set resulting in the material properties as determined by the iteration.

8. The method of claim 1, wherein the microstructural modelling is performed using thermal-history-microstructure-modelling.

9. The method of claim 1, wherein the material modelling is performed using microstructure-material-property-modelling.

10. The method of claim 1, further comprising:
defining a target material property criterium; and
repeating acts (c) through (i) with a changed additive manufacturing process parameter set for each iteration until the target material property is fulfilled by the determined material property of act (i).

11. The method of claim 10, further comprising:
additively manufacturing the component applying the process parameter set resulting in the material properties as determined by the iteration.

12. The method of claim 1, further comprising:
additively manufacturing the component using the material property.

13. A system comprising:
at least one computer configured to:
define an area of interest of a component and generating a mesh at least in the area of interest;
provide a temperature model for modelling temperature of the area of interest during an additive manufacturing process;
provide an additive manufacturing process parameter set;
calculate a thermal history of nodes of the mesh in the area of interest based on the process parameter set using the temperature model;
determine a solidification gradient and a solidification front velocity for the nodes of the area of interest from the thermal history;
select a reduced data set from the data set of solidification gradients and solidification front velocities such that every data point of the data set may be approximated by interpolation from the reduced data set;
determine microstructure characteristics for the reduced data set based on the thermal history of the respective node by microstructural modelling;
determine a material property for the nodes within the reduced data set from the microstructure characteristics using a material property model; and
interpolate the material property from the solidification gradient and solidification front velocity for the nodes within the area of interest.

14. The system of claim 13, further comprising:
a three-dimensional (3D) printing apparatus configured to additively manufacture the component using the material property.
